(19) United States
(12) Patent Application Publication
(10) Pub. No.: US 2002/0173962 A1
(43) Pub. Date: Nov. 21, 2002

(54) Method for generating pesonalized speech from text

(75) Inventors: Donald T. Tang, Mt. Kisco, NY (US); Ligin Shen, Beijing (CN); Qin Shi, Beijing (CN); Wei Zhang, Beijing (CN)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 10/118,497

(22) Filed: Apr. 5, 2002

(30) Foreign Application Priority Data
Apr. 6, 2001 (CN) 01 1 16305.4

(51) Int. Cl. G10L 13/00

(52) U.S. Cl. 704/260

(57) ABSTRACT

A method for generating personalized speech from text includes the steps of analyzing the input text to get standard parameters of the speech to be synthesized from a standard text-to-speech database; mapping the standard speech parameters to the personalized speech parameters via a personalization model obtained in a training process; and synthesizing speech of the input text based on the personalized speech parameters. The method can be used to simulate the speech of the target person so as to make the speech produced by a TTS system more attractive and personalized.

### BACKGROUND OF THE INVENTION

1. Field of the Invention

This invention relates generally to a technique for generating text-to-speech, and particularly to a method for generating personalized speech from text.

2. Brief Description of the Prior Art

The speech generated by general TTS (text-to-speech) systems normally lacks emotion and is monotonous. In the general TTS system, the standard pronunciations of all syllables/words are first recorded and analyzed; and then, at the syllable/word level, the related parameters for expressing the standard pronunciations are stored in a dictionary. Through the standard control parameters defined in the dictionary and smoothing techniques, the speech corresponding to the text is synthesized by concatenating components. The speech synthesized in this way is very monotonous and cannot be personalized.

### SUMMARY OF THE INVENTION

Therefore this invention provides a method for generating personalized speech from text.

The method for generating personalized speech from text according to this invention comprises the steps of: analyzing the input text to get standard speech parameters from a standard text-speech database; mapping the standard speech parameters to the personalized speech parameters by the personalization model obtained in a training process; and synthesizing speech corresponding to the input text based on the personalized speech parameters.

### BRIEF DESCRIPTION OF THE DRAWINGS

The target, advantage and features of the invention will be described by the following figures:

FIG. 1 illustrates a process for generating speech from text in a conventional TTS system;

FIG. 2 illustrates a process for generating personalized speech from text according to this invention;

FIG. 3 illustrates a process for generating a personalization model from text according to a preferred embodiment of this invention;

FIG. 4 illustrates a process of mapping between two sets of cepstra parameters in order to get the personalization model; and

FIG. 5 illustrates a decision tree used in a prosody model.

### DETAILED DESCRIPTION OF THE INVENTION

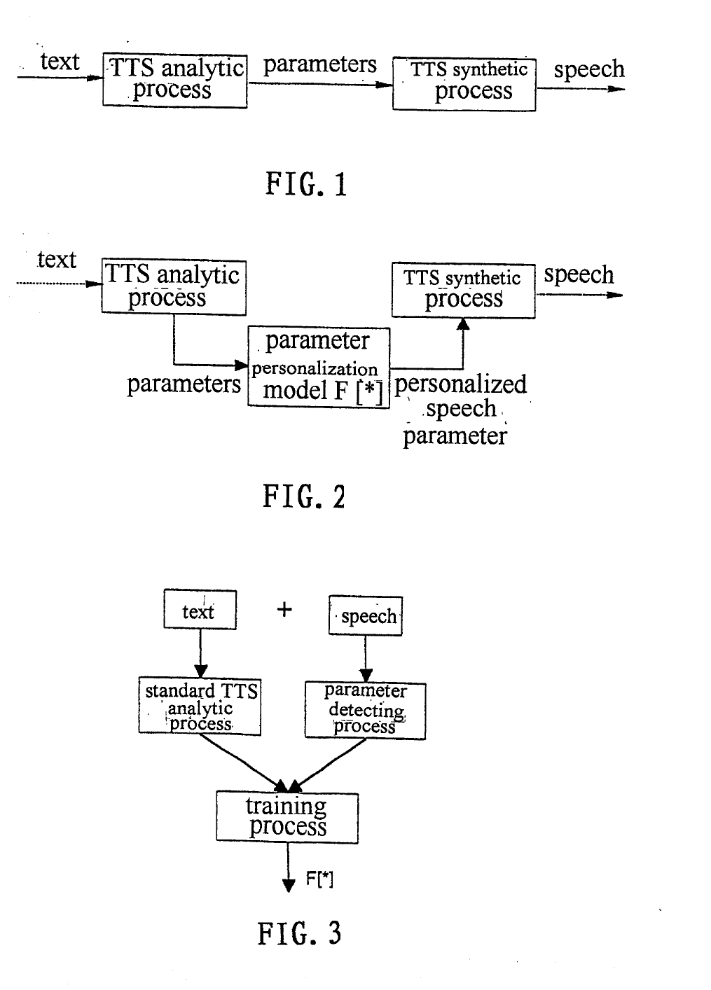

As illustrated in FIG. 1, in order to generate speech from text in a general TTS system, one usually goes through the following steps: firstly, analyzing the input text to get related parameters of standard pronunciation from a standard text-to-speech database; and secondly, concatenating the components to synthesize the speech by the synthesis and smoothing technique. The speech synthesized in this way is very monotonous and hence cannot be personalized.

Therefore, this invention provides a method for generating personalized speech from text.

As illustrated in FIG. 2, the method for generating personalized speech from text according to this invention comprises steps of: firstly, analyzing the input text to get standard speech parameters; secondly, transforming the standard speech parameters to the personalized speech parameters via a personalization model obtained in a training process; and finally, synthesizing speech with the personalized speech parameters.

Now referring to FIG. 3, the process for generating the personalization model will be described. Specifically, in the first instance, to get a personalization model, the standard speech parameters V_{general} are obtained by the standard TTS analysis process; simultaneously, the personalized speech is detected to get its speech parameters V_{personalized}; and the personalization model representing the relationship between the standard speech parameters and the personalized speech parameters is initially created according to the following equation:

V_{personalized}=F [V_{general}] (1)

To get a stable F[*], the process for detecting the personalized speech parameters V_{personalized} will be multiply repeated, and the parameter personalization model F[*] will be adjusted according to the detection results until the stabilized personalization model is obtained. If two adjacent results in the detection meet |Fᵢ[*]−Fᵢ₊₁[*]|≦δ, F[*] will be regarded as stable. According to a preferred embodiment of this invention, this invention achieves the personalization model F[*] representing the relationship between the standard speech parameters V_{general} and the personalized speech parameters V_{personalized} in the following two levels:

Level 1: the cepstra parameters-related acoustic level, and

Level 2: the supra-segmental parameters-related prosody level. Different training methods have been used for the different levels.

Level 1: the Cepstra Parameters-related Acoustic Level

With the speech recognition technique, the speech cepstra parameters sequence can be obtained. If the speech of two persons for the same text is given, not only the cepstra parameters sequence of each person, but also the relationship between the two cepstra parameters sequences at the frame level can be obtained. Therefore the difference between them can be compared frame by frame, and their difference can be modeled and a cepstra parameters-related conversion function F[*] in speech level can be obtained.

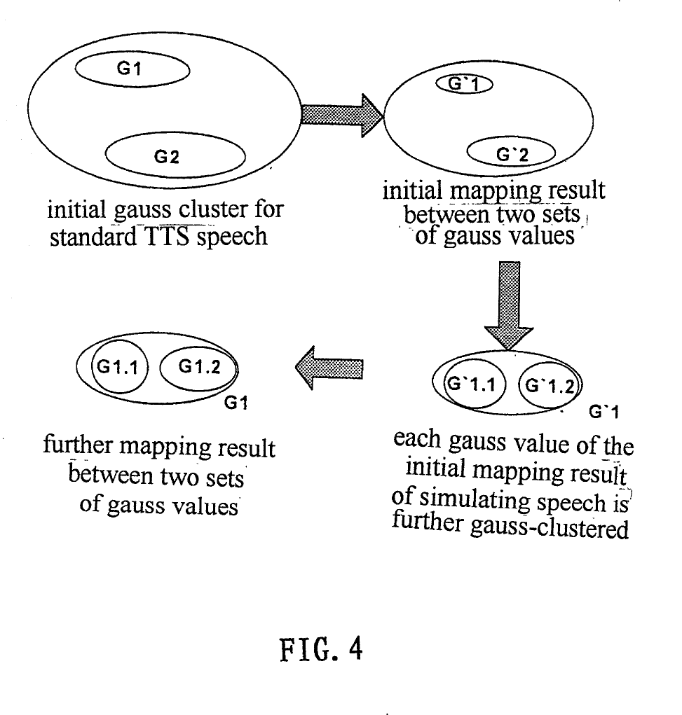

In this model, there are two sets of cepstra parameters defined, one set is from the standard TTS system, the other from the speech of someone who is the target to be simulated. Using the intelligent VQ (vector quantification) method shown in FIG. 4, the mapping between two sets of cepstra parameters can be created. Firstly, the speech cepstra parameters in the standard TTS are initially gauss-clustered to quantify the vectors, and G₁, G₂ is achieved. Secondly, the initial gauss-clustered result of the speech to be simulated is obtained from the strict mapping between two sets of cepstra parameter sequences frame by frame and the initial gauss-clustered results for speech cepstra parameters in standard TTS. In order to get a more accurate model of each Gᵢ, the gauss-clustering is carried out, and G_{1·1}, G_{1·2}, . . . ; G_{2·1}, G_{2·2}, . . . obtained. After that, a one to one mapping among gaussians is obtained, and F[*] is defined as follows:

$${V}_{personalized} = F [ {V}_{general} ] : {V}_{general} ∈ {G}_{i , j} , {V}_{personal} = ( {V}_{general} - {M}_{{G}_{ij}} ) * \frac{{D}_{{G}_{i , j}^{′}}}{{D}_{{G}_{i , j}}} + {M}_{{G}_{i , j}^{′}} \qquad ( 2 )$$

In the above equation, M_{G}_{_{l,j}}, D_{G}_{_{l,j}} express the mean value and variation of G_{i,j}, and M_{G′}_{_{l,j}}, D_{G′}_{_{l,j}}, the mean value and variation of G′_{i,j} respectively.

Level 2: the Supra-segmental Parameters Related Prosody Level

As is well known, prosody parameters are related to the context. The context information comprises: consonant, accent, semanteme, syntax, semantic structure and so on. In order to determine the relationship among context information, a decision tree is used herein to model the transform mechanism F[*] of the prosody level.

Prosody parameters comprise: fundamental frequency values, duration values and loudness values. For each syllable, the prosody vector is defined as follows:

Fundamental frequency values: all fundamental frequency values on 10 points distributed on a whole syllable;

Duration values: 3 values comprising the duration values on the burst part, on the stable part and on the transition part respectively; and

Loudness values: 2 values comprising front and rear loudness values.

A vector with 15 dimensions is used to express the prosody of a syllable.

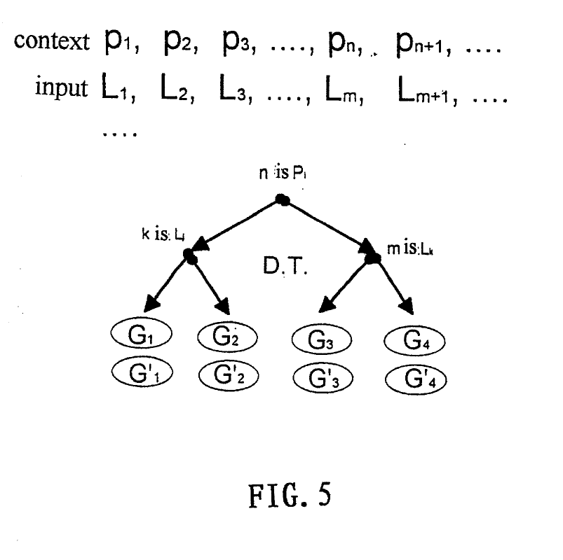

Suppose the prosody vector is of gaussian distribution, so a general decision tree algorithm can be used to cluster the speech prosody vectors of the standard TTS system. Therefore, the decision tree D.T. and gauss values G₁, G₂, G₃ . . . shown in FIG. 5 can be obtained.

When text is input and the speech is to be simulated, the text is first analyzed to get context information, and then the context information is input into decision D.T. to get another set of gauss values G₁′, G₂′, G₃′ . . .

Gauss G₁, G₂, G₃ . . . and G₁′, G₂′, G₄′ . . . are supposed to be one to one mapping, and the following mapping function is constructed:

$${V}_{personalized} = F [ {V}_{general} ] : {V}_{general} ∈ {G}_{i , j} , {V}_{personal} = ( {V}_{general} - {M}_{{G}_{ij}} ) * \frac{{D}_{{G}_{i , j}^{′}}}{{D}_{{G}_{i , j}}} + {M}_{{G}_{i , j}^{′}} \qquad ( 3 )$$

In the equation, M_{Gi,j}, D_{Gi,j} express the mean value and variation of G_{i,j}, and M_{G′}_{_{i,j}}, D_{G′}_{_{i,j}} the mean value and variation of G′_{i,j} respectively.

In the above, the method for generating personalized speech from text is described with FIG. 1-FIG. 5. The key problem herein is to synthesize the analogical signals of consonants from the characteristic vectors in real-time. This is the inverse of the process for extracting digital characters (similar to inverse Fourier transformation). Such a process is very complex, but it can be implemented by a present available special algorithm, such as the technique for reconstructing speech from cepstra parameters invented by IBM.

Although, in general, personalized speech can be created by a real-time transformation algorithm, it can also be predicted that a complete personalized TTS database can be setup for any particular target. Because the transformation and creation of analogical speech components is completed in the final step of creating personalized speech in a TTS system, the method of this invention has no influence in the general TTS system.

In the above, with particular embodiments, the method for generating personalized speech from text in this invention is described. As is well known for those skilled in the art, many modifications and variations of this invention can be made without departing from the spirit of this invention. Therefore, this invention will include all these modifications and variations, and the scope of this invention should be defined by the attached claims.

Further, in view of the foregoing specification, those of skill in the art will appreciate that the present method can be practiced via a software implementation, a hardware implementation, or a combined software-hardware implementation. Accordingly, the present invention contemplates a program storage device readable by a machine and tangibly embodying a program of instruction executable by the machine to perform any or all of the method steps set forth herein.

What is claimed is:

1. A method for generating personalized speech from input text, comprising the steps of:
analyzing the input text to get standard parameters of the speech to be synthesized from a standard text-to-speech database;
mapping the standard speech parameters to personalized speech parameters via a personalization model obtained in a training process; and
synthesizing speech from the input text based on the personalized speech parameters.

2. The method according to claim 1, wherein the personalization model is obtained by steps of:
getting the standard speech parameters through a standard text-to-speech analyzing process;
detecting the personalized speech parameters of the personalized speech;
initially creating the personalization model representing the relationship between the standard speech parameters and the personalized speech parameters; and
repeating the step of detecting the personalized speech parameters, and adjusting the personalization model based on the detection results until the personalization model is stable.

3. The method according to claim 1, wherein the personalization model comprises a personalization model for acoustic level related with cepstra parameters.

4. The method according to claim 3, wherein the personalization model for acoustic level related with cepstra parameters is created by an intelligent Vector Quantification method.

5. The method according to claim 1, wherein the personalization model comprises a personalization model for prosody level related with supra-segmental parameters.

6. The method according to claim 5, wherein the personalization model for prosody level related with supra-segmental parameters is created via a decision tree.

7. A program storage device readable by machine, tangibly embodying a program of instructions executable by the machine to perform method steps for generating personalized speech from input text, said method steps comprising:
analyzing the input text to get standard parameters of the speech to be synthesized from a standard text-to-speech database;
mapping the standard speech parameters to personalized speech parameters via a personalization model obtained in a training process; and
synthesizing speech from the input text based on the personalized speech parameters.
